(19) United States
(12) Patent Application Publication
(10) Pub. No.: US 2025/0340382 A1
(43) Pub. Date: Nov. 6, 2025

(54) AUTOMATED TAPE LIBRARY ROBOTIC RAIL EVALUATION SYSTEM

(71) Applicant: INTERNATIONAL BUSINESS MACHINES CORPORATION, ARMONK, NY (US)

(72) Inventors: Shawn M. Nave, Tucson, AZ (US); Joseph Leveille, Tucson, AZ (US)

(21) Appl. No.: 18/654,407

(22) Filed: May 3, 2024

(51) Int. Cl. B65G 43/00; B65G 1/137

(52) U.S. Cl. CPC B65G 43/00; B65G 1/1371; B65G 2203/0275

(57) ABSTRACT

According to one embodiment, a method, computer system, and computer program product for performing a rail system check within an automated tape library is provided. The present invention may include moving a robot to a starting position along a rail system of the automated tape library; setting a motor velocity of the robot lower than its normal velocity; initiating a rail system check process; consistently collecting a plurality of measurement data during the rail system check process; analyzing the collected plurality of measurement data; and determining if one or more rail system problems exist in the automated tape library based on the analysis of the collected plurality of measurement data.

### BACKGROUND

The present invention relates, generally, to the field of computing, and more particularly to automated tape libraries.

Automated tape libraries are commonly used to store a high quantity of data at low costs. Automated tape libraries operate using a robot to move tape cartridges from storage locations to tape drives. Upon being moved to a tape drive, a tape cartridge can be read or written to.

### SUMMARY

Embodiments of a method, a computer system, and a computer program product for performing a rail system check within an automated tape library are described. According to one embodiment, a method, computer system, and computer program product for performing rail joint checks within an automated tape library may include moving a robot to a starting position along a rail system of the automated tape library; setting a motor velocity of the robot lower than its normal velocity; initiating a rail system check process; consistently collecting a plurality of measurement data during the rail system check process; analyzing the collected plurality of measurement data; and determining if one or more rail system problems exist in the automated tape library based on the analysis of the collected plurality of measurement data.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 depicts a block diagram of the components of an automated tape library system according to at least one embodiment.

FIG. 3 is an operational flowchart illustrating an automated tape library robotic rail system evaluation process according to at least one embodiment.

FIG. 4 is an illustration of an automated tape library according to at least one embodiment.

FIG. 5 is an illustration of an automated tape library with acceptable and unacceptable rail joints according to at least one embodiment.

FIG. 6 is an illustration of a graph of the measured current experienced during the application of the automated tape library robotic rail system evaluation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of computing, and in particular to automated tape libraries. The present embodiment has the capacity to improve the monitoring and detection of problems in robot rail systems within an automated tape library. The present embodiment can use feedback mechanisms from the robot to detect any gaps between rail segments, misalignment of rail tracks, and/or damage to a robotic rail system.

Automated tape libraries comprise a robot that is used to move tape cartridges within the tape library between storage slots and read/write drives. The tape libraries include a rack/rail system, referred to herein as a “rail system”, on which the robots move along. A common type of rail system includes a guide rail integrated with a gear rack which allows the robot with a rack and pinion type of propulsion to be guided and move throughout the tape library. Automated tape libraries may comprise multiple rail systems, such as in larger libraries. The rail systems are made up of segments of rails that join together to allow the robot to travel along the multiple rail systems, and thus along the entire length of the automated tape library. Due to assembly processes and variations in parts, there can sometimes be gaps or misalignments between adjacent rail segments. If the gap or misalignment is too large, there can be unnecessary vibration or damage induced on the robot as it travels across the gap, as well as cause a shortened life span of the rack and pinion drive system from the robot moving across an uneven gap. Additionally, small gaps can cause long-term robotic life problems or vibrational problems that are more difficult to detect with the robotic control system, as well as affect the positional accuracy of the robot.

Currently, rail joint checks within an automated tape library are performed manually by a human operator or by assembly personnel. These types of checks can involve using tools such as rack alignment tools, feeler gauges, or simple measurement equipment, for example, rulers or calipers. However, the current methods are subject to human error, such as forgetting to measure every gap between rail joints, or incorrectly using the measurement tools to accurately measure the gaps or anomalies in the rail system. Additionally, the current methods take significant time to perform and are limited to the accuracy of a human using basic hand tools. Thus, an implementation of an automated detection system that can check for problems in a rail system of an automated tape library is needed.

Thus, embodiments of the present invention may provide advantages including, but not limited to, detecting if the gaps within an automated tape library, alignment of the rail segments, as well as damage to the rail system, are acceptable for robotic travel so that both the robot and the rack and pinion drive system are not subject to the above-mentioned negative side effects. The present invention can perform a rail system check process in which a robot travels the full length of the tape library, thereby, ensuring that the entirety of the tape library is checked for problems. Also, the present invention can analyze measured data collected during the rail system check process, thereby, ensuring that the location of each problem in the rail system is pinpointed. The present invention does not require that all advantages need to be incorporated into every embodiment of the invention.

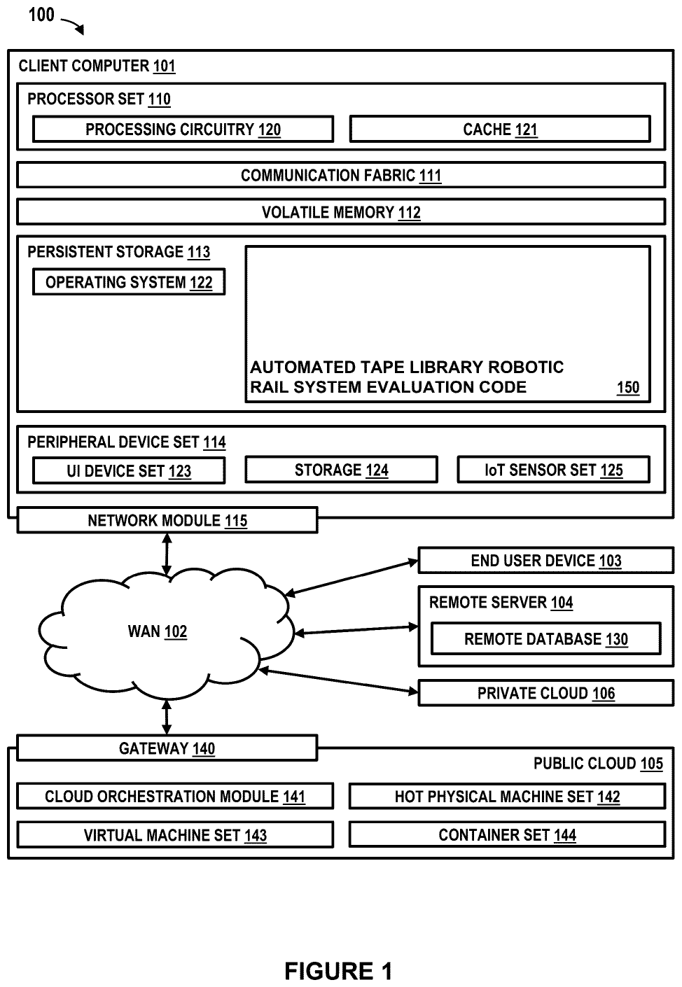

The embodiments mentioned in this paragraph are further illustrated and described below in the discussions of FIGS. 1 through 6. According to at least one embodiment, the present invention moves a robot to a starting position along a rail system of the automated tape library. Also, the present invention sets a motor velocity of the robot lower than its normal velocity. Furthermore, the system initiates a rail system check process. Moreover, the present invention consistently collects a plurality of measurement data during the rail system check process. The present invention analyzes the collected plurality of measurement data. Additionally, the present invention determines if one or more rail system problems exist in the automated tape library based on the analysis of the collected plurality of measurement data.

According to at least one other embodiment, responsive to determining that no rail system problems exist in the automated tape library, the present invention reports a successful rail system check. According to at least one other embodiment, responsive to determining that one or more rail system problems exist in the automated tape library, the present invention reports a failed rail system check. According to at least one other embodiment, the failed rail system check comprises a location along the rail system identifying each of the one or more rail system problems. According to at least one other embodiment, the automated tape library can comprise a vertical orientation for robotic motion. According to at least one other embodiment, the automated tape library can comprise a horizontal orientation for robotic motion. According to at least one other embodiment, the one or more rail system problems can comprise a rail joint gap distance that is too large, misalignments between rail segments, and/or damage to the rail system.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to move a robot to a starting position along a rail system of the automated tape library, set a motor velocity of the robot lower than its normal velocity, initiate a rail system check process, consistently collect a plurality of measurement data during the rail system check process, analyze the collected plurality of measurement data, and determine if one or more rail system problems exist in the automated tape library based on the analysis of the collected plurality of measurement data.

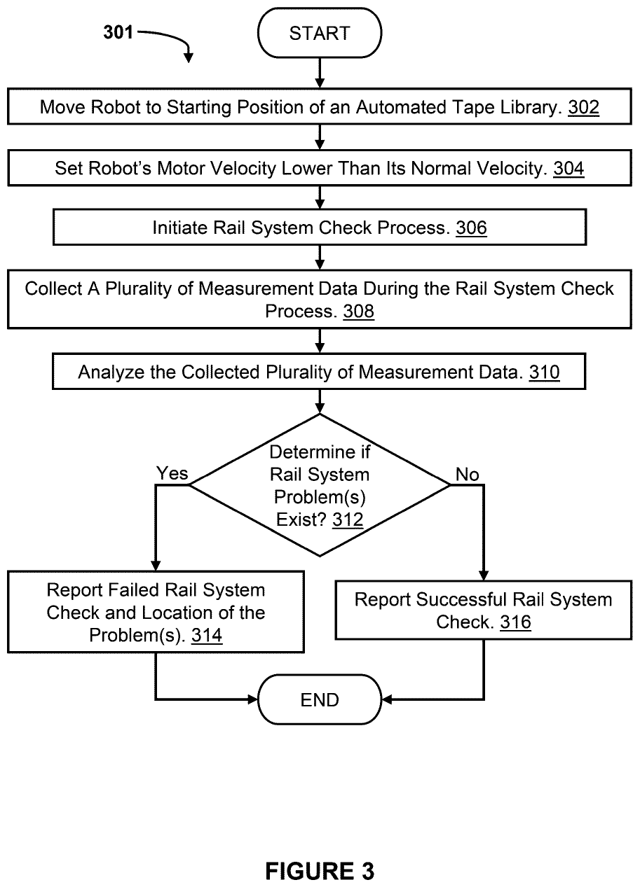

Referring to FIG. 1, an exemplary networked computer environment 100 is depicted, according to at least one embodiment. Computing environment 100 contains an example of an environment for the execution of at least some of the computer code involved in performing the inventive methods, such as automated tape library robotic rail system evaluation code 150, also referred to as “automated tape library robotic rail system evaluation algorithm 150”, or “the algorithm 150”. In addition to code block 150 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 150, as identified above), peripheral device set 114 (including user interface (UI), device set 123, storage 124, and Internet of Things (IOT) sensor set 125), and network module 115. In at least one embodiment, peripheral device set 114 may comprise a sensor built into the robot 410 (FIG. 3). Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. The database 130 may be a digital repository capable of data storage and data retrieval. The database 130 can be present in the remote server 104 and/or any other location in the network 102. The database 130 may store measurement data. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

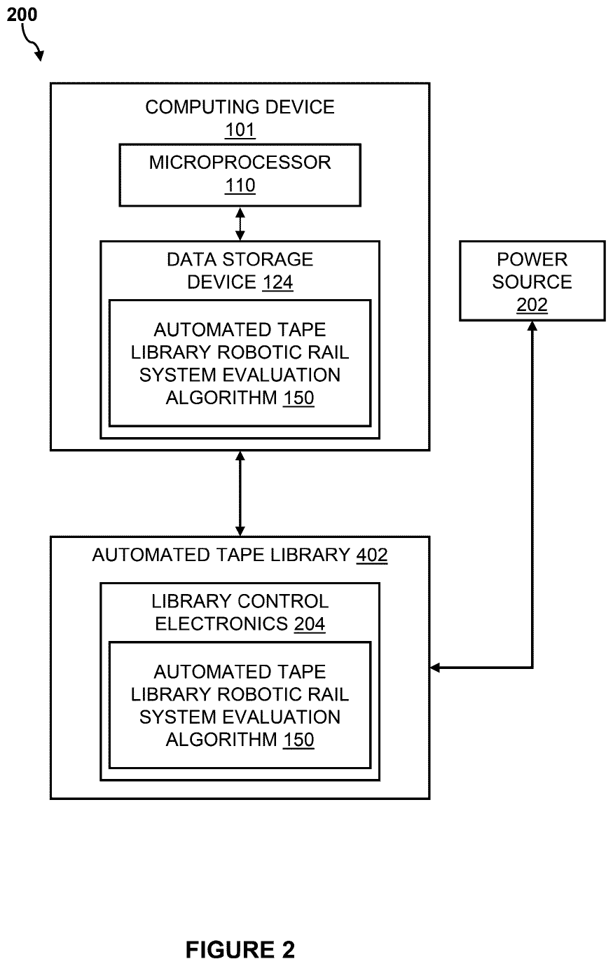

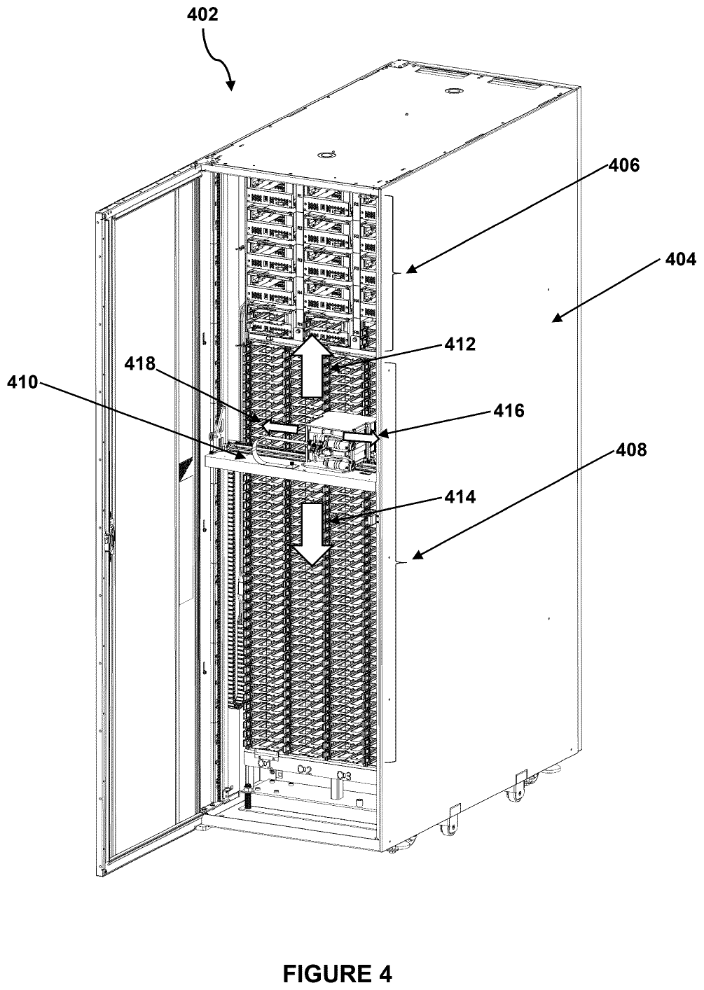

Referring to FIG. 2, a high-level partial block diagram of the components of an automated tape library system 200, is depicted, according to at least one embodiment. FIG. 2 may include client computing device 101 and an automated tape library 402 (FIG. 4) interconnected via a communication network 102, and a power source 202. It should be understood that additional system architecture directed to certain aspects of the operation that are not required for an understanding of the present invention, such as sensor 114, motor controller, spooling assembly, tape drives, cartridges, cartridge slots, guide rollers, pinion gears, tape formatting, read/write functions, etc., has not been depicted for ease of illustration. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run an automated tape library robotic rail system evaluation algorithm 150 and communicate with the automated tape library 402 via the communication network 102, in accordance with one embodiment of the invention.

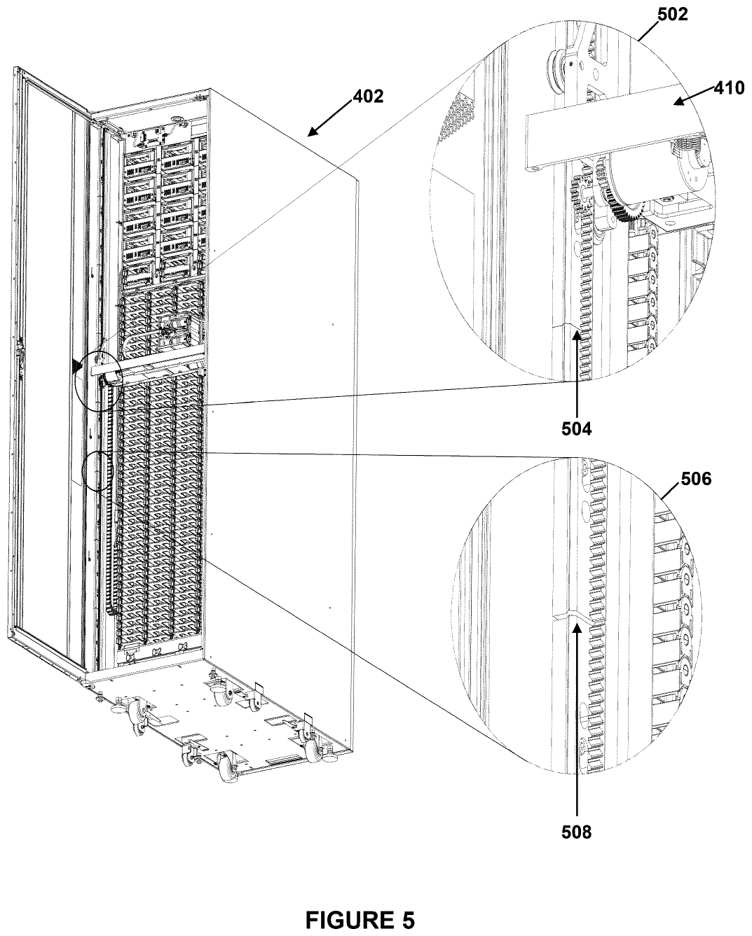

Automated tape library 402 can comprise one or more tape library frames 404, tape drives 406, tape storage slots 408, and a robot 410, as depicted in FIG. 4. A multitude of tape cartridges can be stored in tape storage slots 408. The tape cartridges can be loaded into the plurality of tape drives 406 for reading/writing data from/onto the tape cartridges. The robot 410 can move the tape cartridges from the tape storage slots 408 to the tape drives 406. Arrows 412, 414 depict the vertical motion that the robot 410 can travel along within the automated tape library 402. Arrows 416, 418 depict the horizontal motion that the robot 410 can travel along within the automated tape library 402. Additionally, an automated tape library 402 may comprise acceptable rail joint gaps 504, unacceptable rail joint gaps 508, or both acceptable and unacceptable rail joint gaps 504, 508, as depicted in FIG. 5. An acceptable rail joint gap 504 may be a gap between two rail joints that the robot 410 can traverse over without drawing an unacceptable spike in current output beyond a predetermined threshold. An unacceptable rail joint gap 508 may be a gap between two rail joints that requires the robot 410 to draw a spike in current output to traverse over the gap. A first magnified view 502 of a part of the automated tape library 402 includes the robot 410 and an example of an acceptable rail joint gap 504. A second magnified view 506 of a part of the automated tape library 402 includes an example of an unacceptable rail joint gap 508.

According to the present embodiment, the automated tape library robotic rail system evaluation algorithm 150 may be an algorithm capable of initiating and conducting a rail system check process within an automated tape library. Also, the algorithm 150 may be a system capable of analyzing a plurality of measurement data collected during the rail system check process. Additionally, algorithm 150 may be an algorithm capable of determining if one or more rail system problems exist within the automated tape library. Moreover, the algorithm 150 may be an algorithm capable of reporting a failed rail system check and the location of the rail system problems or reporting a successful rail system check. The algorithm 150 may be located on the library control electronics 204 embedded in the automated tape library device 402 or on the client computing device 101, as depicted in FIG. 2. Additionally, the algorithm 150 may be located on the remote server 104 or on any other device located within network 102. Furthermore, the algorithm 150 may be distributed in its operation over multiple devices, such as client computing device 101 and remote server 104. The algorithm 150 is explained in further detail below with respect to FIG. 3.

Referring now to FIG. 3, an operational flowchart illustrating an automated tape library robotic rail system evaluation process 301 is depicted according to at least one embodiment. At 302, the algorithm 150 moves the robot 410 to the starting position of the automated tape library 402, for example, at the bottom of a vertical automated tape library. An example of a vertical automated tape library 402 may be an IBM™ Diamondback tape library (IBM™ and all IBM™-based trademarks and logos are trademarks or registered trademarks of IBM Corporation, and/or its affiliates), as depicted in FIGS. 4 and 5. The robot 410, also known as a robotic accessor or a robotic assembly, can inventory tape cartridges in the tape library 402. The robot 410 can comprise fingers that enable it to grab tape cartridges, a sensor 114, a motor, a motor controller, a spooling mechanism, and a bar code reader, built into the robot 410. The robot 410 can be attached to both sides of the automated tape library 402. The algorithm 150 can move the robot in both the vertical and horizontal directions using the robot's 410 motor and motor controller. The starting position for vertical motion 412, 414 can be located at the bottom of the rail system within the automated tape library 402 and the starting position for horizontal motion 416, 418 can be the center of the robot assembly 410. The bottom of the rail system can be located at the bottom of the rail segment below the first rail joint.

In at least one embodiment, the starting position for vertical motion 412, 414 may be located at the top of the rail system within the automated tape library 402 and the starting position for horizontal motion 416, 418 can be the center of the robot assembly 410.

In at least one embodiment, the starting position starting position for horizontal motion may be located at either the left end or the right end of the rail system and the starting position for vertical motion may be the center of the rail system, such as in embodiments comprising an automated tape library with a horizontal rail system. An example of a horizontal automated tape library may be an IBM™ TS4500 Tape Library (IBM™ and all IBM™-based trademarks and logos are trademarks or registered trademarks of IBM Corporation, and/or its affiliates).

At 304, the algorithm 150 sets the robot's 410 motor velocity lower than its normal velocity using the robot's 410 motor controller. The algorithm 150 may set the robot's 410 motor velocity to a value within a range of 0-100% of the normal velocity parameter via the robot's 410 motor controller. The algorithm 150 can set the robot's 410 motor velocity to a quantity that represents a slow velocity. A slow velocity can comprise a lower percentage of the normal maximum velocity, such as 5%, 10%, etc. In at least one embodiment, the algorithm 150 can set the velocity parameter to 5% of the normal maximum velocity to ensure accurate feedback is gathered by the robot 410 during the rail system check process.

At 306, the algorithm 150 initiates the rail system check process. The rail system check process can comprise moving the robot 410 upwards from the bottom of the rail system to the top of the rail system in the vertical direction. The algorithm 150 can move the robot 410 at the set velocity during the entirety of the rail system check process by varying the amount of current applied to the robot's 410 motor to, for example, go over larger gaps or bumps, so that the set velocity is consistently achieved. During the rail system check process, the robot's 410 guide rollers and pinion gear can cross all the rail joints between the rail segments over the full length of the automated tape library 402.

In at least one embodiment involving the starting position located at the top of the rail system in the vertical direction and the center of the rail system in the horizontal direction, the rail system check process may comprise moving the robot 410 downwards from the top of the rail system to the bottom of the rail system in the vertical direction.

In at least one embodiment involving an automated horizontal tape library, the rail system check process may comprise moving the robot 410 horizontally from either the left end of the rail system to the right end of the rail system, or the right end of the rail system to the left end of the rail system.

At 308, the algorithm 150 collects a plurality of measurement data during the rail system check process. The robot 410 can take measurements of its motor current output (mA), i.c. how much power the robot 410 is drawing, and its vertical position (0.1 mm) on the rail system using the built-in sensor 114 and the motor as the robot 410 moves across the entire rail system. The algorithm 150 can continuously poll the sensor 114 in the robot 410 and the robot's 410 motor to dynamically collect the robot's 410 position and the robot's 410 motor current output during the rail system check process. The algorithm 150 can store the measurement values in an array for processing, for example, in the database 130.

In at least one embodiment involving an automated horizontal tape library, the robot 410 can take measurements of its motor current (mA) output and its horizontal position (0.1 mm) on the rail system during the rail system check process.

At 310, the algorithm 150 analyzes the collected plurality of measurement data. The algorithm 150 can determine the length of a single rail segment based on comparing the robot's 410 starting position to the position at which the robot's 410 guide wheels/pinion gear are even with the first rail joint gap. The algorithm 150 can calculate the positions where all the rail joints should be detected between the rail segments in the rail system based on the length of a single rail segment and the length of the entire rail system. The algorithm 150 can analyze the collected plurality of measurement data to determine the robot's 410 motor current output at each position along the rail system during the rail system check process. The algorithm 150 can create a visualization of the measurement data by graphing the measurement data as a line graph in which the vertical position of the robot 410 is represented along the x-axis and the motor current output is represented along the y-axis. The graph can display the motor current at regular intervals that line up with cach rail joint in the rail system. Additionally, the algorithm 150 may format the measurement data in a table, comprising the vertical position, or in some embodiments, the horizontal position, of the robot 410 and the motor current output.

At 312, the algorithm 150 determines whether one or more rail system problems have been detected. According to one implementation, if the algorithm 150 determines that one or more rail system problems have been detected (step 312, “YES” branch), the algorithm 150 may continue to step 314 to report a failed rail system check and the location of the one or more problems along the rail system. A rail system problem can comprise a rail joint gap distance that is too large, misalignments between rail segments, damage to the rail system, such as a damaged rack tooth, as well as external damage, such as a cracked or deformed gear rack tooth or debris in the gear rack or a dent or divot in the guide rail. The algorithm 150 can determine that one or more rail system problems have been detected if there is a spike in the measured motor current output data above a predetermined threshold. A spike in the measured motor current output data can represent an increase in the current draw of the motor, meaning the motor had a tougher time moving the robot 410 past a certain point along the rail system and needed to draw more power to do so. The algorithm 150 can use a predetermined threshold that can be determined through experimentation, such as by measuring current output through large gaps, normal gaps, and external damage, and using different motor velocities. If the algorithm 150 determines that no rail system problems have been detected (step 312, “NO” branch), the algorithm 150 may continue to step 316 to report a successful rail system check.

At 314, the algorithm 150 reports a failed rail system check and the location of the one or more problems. A failed rail system check can comprise a push notification, appearing on the GUI of an EUD 103, that displays the rail system check failed and that one or more rail system problems were found. Additionally, a failed rail system check can comprise the locations of the one or more rail system problems, allowing the damaged or mis-installed rail segment to be accurately and quickly found.

At 316, the algorithm 150 reports a successful rail system check. A successful rail system check can comprise a push notification, appearing on the GUI of an EUD 103, that displays the rail system check was successful and that no rail system problems were found.

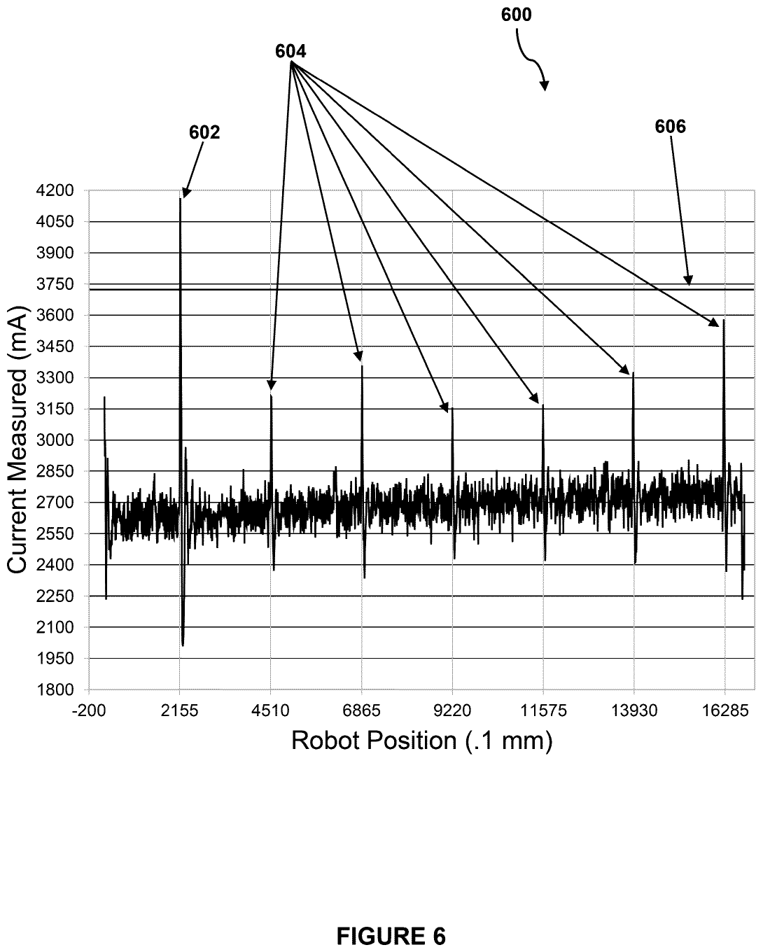

Referring now to FIG. 6, an example line-graph 600 generated during an application of the automated tape library robotic rail system evaluation process 301 is depicted according to at least one embodiment. The x-axis of the graph 600 depicts the position of the robot 410 on the rail system along the vertical axis (0.1 mm). The y-axis of the graph 600 depicts the motor current output (mA). A larger spike of motor current output 602 depicts the robot 410 crossing over an unacceptable rail joint gap. Smaller spikes of motor current output 604 depict the robot 410 crossing over acceptable rail joint gaps. A measured current threshold for determining an unacceptable rail joint gap 606 is depicted around 3,750 mA along the y-axis.

It may be appreciated that FIGS. 2 through 6 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for performing a rail system check within an automated tape library, the method comprising:
moving a robot to a starting position along a rail system of the automated tape library;
setting a motor velocity of the robot lower than its normal velocity;
initiating a rail system check process;
consistently collecting a plurality of measurement data during the rail system check process;
analyzing the collected plurality of measurement data; and
determining if one or more rail system problems exist in the automated tape library based on the analysis of the collected plurality of measurement data.

2. The method of claim 1, the method further comprising:
responsive to determining that no rail system problems exist in the automated tape library, reporting a successful rail system check.

3. The method of claim 1, the method further comprising:
responsive to determining that one or more rail system problems exist in the automated tape library, reporting a failed rail system check.

4. The method of claim 3, wherein the failed rail system check comprises a location along the rail system identifying each of the one or more rail system problems.

5. The method of claim 1, wherein the automated tape library can comprise a vertical orientation for robotic motion.

6. The method of claim 1, wherein the automated tape library can comprise a horizontal orientation for robotic motion.

7. The method of claim 1, wherein the one or more rail system problems can comprise a rail joint gap distance that is too large, misalignments between rail segments, and/or damage to the rail system.

8. A computer system for performing a rail system check within an automated tape library, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
moving a robot to a starting position along a rail system of the automated tape library;
setting a motor velocity of the robot lower than its normal velocity;
initiating a rail system check process;
consistently collecting a plurality of measurement data during the rail system check process;
analyzing the collected plurality of measurement data; and
determining if one or more rail system problems exist in the automated tape library based on the analysis of the collected plurality of measurement data.

9. The computer system of claim 8, the method further comprising:
responsive to determining that no rail system problems exist in the automated tape library, reporting a successful rail system check.

10. The computer system of claim 8, the method further comprising:
responsive to determining that one or more rail system problems exist in the automated tape library, reporting a failed rail system check.

11. The computer system of claim 10, wherein the failed rail system check comprises a location along the rail system identifying each of the one or more rail system problems.

12. The computer system of claim 8, wherein the automated tape library can comprise a vertical orientation for robotic motion.

13. The computer system of claim 8, wherein the automated tape library can comprise a horizontal orientation for robotic motion.

14. The computer system of claim 8, wherein the one or more rail system problems can comprise a rail joint gap distance that is too large, misalignments between rail segments, and/or damage to the rail system.

15. A computer program product for performing a rail system check within an automated tape library, the computer program product comprising:
one or more computer-readable tangible storage medium and program instructions stored on at least one of the one or more tangible storage medium, the program instructions executable by a processor to cause the processor to perform a method comprising:
moving a robot to a starting position along a rail system of the automated tape library;
setting a motor velocity of the robot lower than its normal velocity;
initiating a rail system check process;
consistently collecting a plurality of measurement data during the rail system check process;
analyzing the collected plurality of measurement data; and
determining if one or more rail system problems exist in the automated tape library based on the analysis of the collected plurality of measurement data.

16. The computer program product of claim 15, the method further comprising:
responsive to determining that no rail system problems exist in the automated tape library, reporting a successful rail system check.

17. The computer program product of claim 15, the method further comprising:
responsive to determining that one or more rail system problems exist in the automated tape library, reporting a failed rail system check.

18. The computer program product of claim 17, wherein the failed rail system check comprises a location along the rail system identifying each of the one or more rail system problems.

19. The computer program product of claim 15, wherein the automated tape library can comprise a vertical orientation for robotic motion.

20. The computer program product of claim 15, wherein the automated tape library can comprise a horizontal orientation for robotic motion.
